(19) United States
(12) Patent Application Publication
(10) Pub. No.: US 2026/0166439 A1
(43) Pub. Date: Jun. 18, 2026

(54) DETECTING AND INSTRUMENTING PLATFORM-SPECIFIC FEATURES IN A GAME BUILD SYSTEM

(71) Applicant: Sony Interactive Entertainment Inc., Tokyo (JP)

(72) Inventor: John Afsal Elias Kuner, San Francisco, CA (US)

(73) Assignee: Sony Interactive Entertainment Inc., Tokyo (JP)

(21) Appl. No.: 18/986,204

(22) Filed: Dec. 18, 2024

(51) Int. Cl. A63F 13/67; A63F 13/533; A63F 13/5375; A63F 13/79

(52) U.S. Cl. CPC A63F 13/67; A63F 13/533; A63F 13/79; A63F 13/5375

(57) ABSTRACT

Techniques for detecting and instrumenting platform-specific features in a game build system are provided. In an example, one or more machine learning models identify a definition in program code of a video game for an instance of game content, generate an identifier for the instance of game content based on the definition, identifying one or more functional components in the program code that cause a modification to a state of the instance of game content when executed, and generate an event definition for the instance of game content that includes the identifier for the instance of game content based on the modification. Event instrumentation configured to, upon execution, generate event data according to the event definition are generated by the one or more machine learning models. The one or more functional components in the program code are then modified to include the event instrumentation.

### BACKGROUND

Video games are available on different computing devices. For example, a video game developer may develop the same game for users of a first video game platform, a second video game platform, or both. In addition, video games are available from different sources. For example, a video game console associated with the first video game platform is operable to play multiple video games from two or more different video game developers.

Given the increasing number of video games from different developers, the user experience typically changes from one video game to the next. For example, the way game play help may be sought can vary significantly between video games. In addition, the way a particular part of a video game is surfaced on a computing device as being available for playing can be unique to the particular video game.

Hence, the user experience may not be common between video games. Accordingly, there is a need for improving the user experience such that, regardless of the underlying video games, some commonality in video game functionalities becomes possible.

### BRIEF SUMMARY

Embodiments of the present disclosure relate to techniques for detecting and instrumenting platform-specific features in a game build system. In some embodiments, a method implemented by a computer system is provided. The method may include identifying, by one or more machine learning models, a definition in program code of a video game for an instance of game content. The method may further include generating, by the one or more machine learning models, an identifier for the instance of game content based on the definition. The method may further include identifying, by the one or more machine learning models, one or more functional components in the program code that cause a modification to a state of the instance of game content when executed. The method may further include generating, by the one or more machine learning models, an event definition for the instance of game content based on the modification, wherein the event definition includes the identifier for the instance of game content. The method may further include generating, by the one or more machine learning models, event instrumentation configured to, upon execution, generate event data according to the event definition. The method may further include modifying the one or more functional components in the program code to include the event instrumentation.

In some embodiments, upon execution by the video game console, the event instrumentation further causes transmission of the event data to a video game platform. In some embodiments, the event data comprises an identification of a user account associated with a video game console; a timestamp indicating when the one or more functional components were executed by the video game console; and the identifier for the instance of game content.

The method may further include transmitting the identifier and the event definition for the instance of game content to the video game platform. In some embodiments, in response to receiving the event data from a video game console, the event data is stored in a data store in association with the content metadata and the event definition for the instance of game content.

The method may further include: identifying, by the one or more machine learning models, a type of game content that corresponds to the instance of game content from a plurality of game content types common to a plurality of video games including the video game based on the definition in the program code; and generating, by the one or more machine learning models, content metadata for the instance of game content based on the definition in the program code, wherein the content metadata comprises the identifier for the instance of game content and one or more attributes that are common to the type of game content in the plurality of video games. In some embodiments, the plurality of game content types comprises an activity content type, an actor content type, a mechanic content type, and a zone content type.

In some embodiments, the instance of game content corresponds to an activity in the video game, the one or more functional components correspond to a start of the activity in the video game. In some embodiments, the instance of game content corresponds to an activity in the video game, the one or more functional components correspond to an end of the activity in the video game, and the event instrumentation generates the event data with a completion status of the activity by a player. In some embodiments, the instance of game content corresponds to an activity in the video game, the one or more functional components cause the activity to become available in the video game, and the event instrumentation generates the event data to indicate that the activity is available to a player.

In some embodiments, a computer system is provided. The computer system may comprise one or more processors and one or more memories storing computer-readable instructions. Upon execution by the one or more processors, the computer-readable instructions may configure the computer system to identify, by one or more machine learning models, a definition in program code of a video game for an instance of game content. The computer system may be further configured to generate, by the one or more machine learning models, an identifier for the instance of game content based on the definition. The computer system may be further configured to identify, by the one or more machine learning models, one or more functional components in the program code that cause a modification to a state of the instance of game content when executed. The computer system may be further configured to generate, by the one or more machine learning models, an event definition for the instance of game content based on the modification, wherein the event definition includes the identifier for the instance of game content. The computer system may be further configured to generate, by the one or more machine learning models, event instrumentation configured to, upon execution, generate event data according to the event definition. The computer system may be further configured to modify the one or more functional components in the program code to include the event instrumentation.

In some embodiments, one or more non-transitory computer-readable media are provided. The computer-readable media may store computer-readable instructions that, upon execution on a computer system, cause the computer system to perform operations comprising identifying, by one or more machine learning models, a definition in program code of a video game for an instance of game content. The operations may further comprise generating, by the one or more machine learning models, an identifier for the instance of game content based on the definition. The operations may further comprise identifying, by the one or more machine learning models, one or more functional components in the program code that cause a modification to a state of the instance of game content when executed. The operations may further comprise generating, by the one or more machine learning models, an event definition for the instance of game content based on the modification, wherein the event definition includes the identifier for the instance of game content. The operations may further comprise generating, by the one or more machine learning models, event instrumentation configured to, upon execution, generate event data according to the event definition. The operations may further comprise modifying the one or more functional components in the program code to include the event instrumentation.

### BRIEF DESCRIPTION OF THE DRAWINGS

FIG. 1 illustrates an example of a computing environment for collecting and processing video game events, according to embodiments of the present disclosure.

FIG. 2 illustrates an example of a system architecture for providing users with contextual information regarding available game activities, according to embodiments of the present disclosure.

FIG. 3 illustrates another example of a system architecture, according to embodiments of the present disclosure.

FIG. 4 illustrates an example of a system for providing a data model for a universal data platform, according to embodiments of the present disclosure.

FIG. 5 illustrates an example of a system architecture for providing game-related content and services to users in a uniform manner across video games, according to embodiments of the present disclosure.

FIG. 6 illustrates another example of a system architecture for providing game-related content and services to users in a uniform manner across video games, according to embodiments of the present disclosure.

FIG. 7 illustrates an example of an activity hierarchy, according to embodiments of the present disclosure.

FIG. 8 illustrates an example of a user interface for presenting information about an estimated length of time for completing an activity, according to embodiments of the present disclosure.

FIG. 9 illustrates an example of displaying video game help through a user interface, according to embodiments of the present disclosure.

FIG. 10 illustrates an example of a help tip display through a user interface, according to embodiments of the present disclosure, presenting help tip windows containing mechanic tips selected for the player.

FIG. 11 illustrates an example of a flow for instrumenting video games with support for universal game content reporting, according to embodiments of the present disclosure.

FIG. 12 illustrates an example another flow for instrumenting video games with support for universal game content reporting, according to embodiments of the present disclosure.

FIG. 13 illustrates an example of a hardware system suitable for implementing a computer system, according to embodiments of the present disclosure.

### DETAILED DESCRIPTION

Generally, systems and methods for improving a user video game experience are described. In an example, the user video game experience is improved by providing a unified way for, among other things, multiple video game functionalities, such as for suggesting video game activities, estimating completion time for such activities, and presenting video game help regardless of the underlying video games. This unified way need not change how a video game is developed or necessitate a common approach to video game development. Instead, instrumentation of various events in the video games is relied upon, where a video game platform (e.g., a server-based video game service) can collect and process such events based on the execution of the video games to, among other things, suggest the video game activities, estimate completion times, and present the video game help at a client level and, as needed, to customize such video game functionalities to the client level.

For instance, a video game includes a plurality of activities. When an instance of the video game is executed for a video game player (whether locally on a computing device of the video game player or remotely on the video game platform), the video game platform receives events about played activities. Each event can identify the activity, its type, its start time, its end time, and/or potentially its outcome (e.g., success or failure). Events for multiple activities and multiple video game players are stored over time in a data store. The video game platform generates, for each activity and from the stored events, an estimated length of time for completing the activity. For a user that has not completed an activity of the video game, the corresponding length of time is presented on a user device associated with the user. Such completion time estimation can be performed per activity and across different video games. Hence, the same type of video game functionality (e.g., completion time estimation) can be surfaced to a computing device regardless of the video games (as long as the relevant events are collected).

During and/or after development of the video game, the video game developer can use one or more machine learning models to identify the components of the software package that correspond to the plurality of activities and create the instrumentation that will generate the corresponding events during execution of the video game. The machine learning models can be trained on software for video games that have already been instrumented in order to identify the components in new video game software where instrumentation may be appropriate and subsequently instrument the new video game software accordingly.

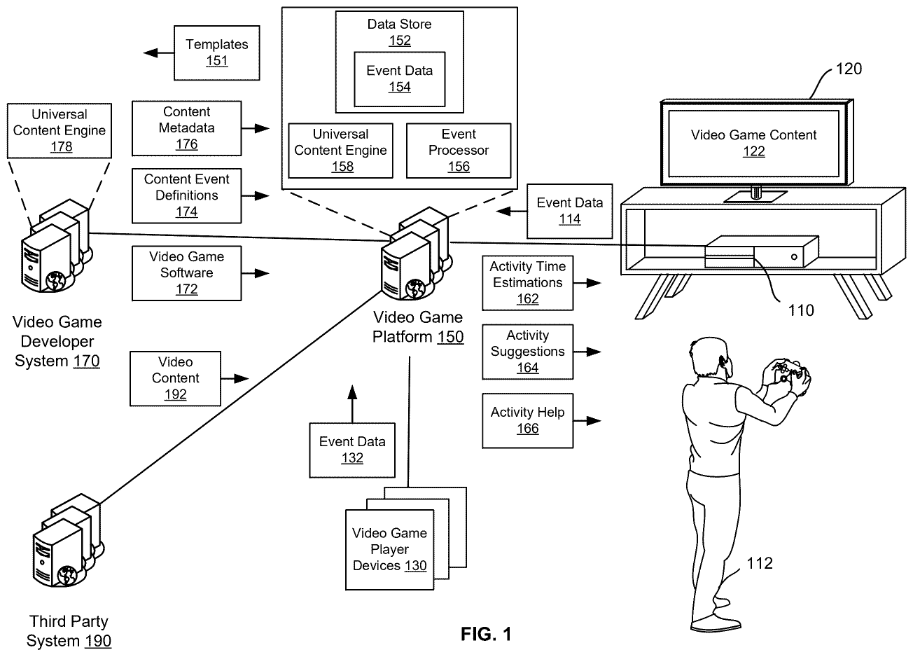

FIG. 1 illustrates an example of a computing environment for collecting and processing video game events, according to embodiments of the present disclosure. As illustrated, the computing environment includes a video game console 110, video game player devices 130, a video game platform 150, a video game developer system 170, and a third party system 190. Video games are available to the video game console 110 from the video game developer system 170 through the video game platform 150. Video content, such as help videos demonstrating how video game activities can be played, is also available to the video game console 110 from the third party system 190 through the video game platform 150. The video game platform 150 collects, stores, and processes events from the video game player devices 130 and the video game console 110 to provide video game-related functionalities in a unified way for each video game.

In an example, the video game console 110 represents a computing device available to a user 112 and operable to interact with one or more applications including video games. A display 120 communicatively coupled or integrated with the video game console 110 can present video game-related data, including video game content 122, to the user 112. Other types of computing devices can be available to the user 112 including for instance, a smartphone, a tablet, a laptop, a desktop computer, or other devices with suitable memories and processors.

The video game console 110 can execute a video game locally to present the video game content 122 on the display 120. Additionally, or alternatively, the video game consoles 110 can receive the video game content 122 based on an execution of an instance of the video game application on the video game platform 150, the video game developer system 170, or another remote computer system. The video game can also be downloadable to the video game console 110 from such systems.

Further, the video game console 110 can, directly or through the video game platform 150, download or stream video content from the third party system 190 for presentation on the display 120. An example of video content includes a video file generated by the video game developer 170 and uploaded to the third party system 190, where this video file demonstrates how a video game can be played, how a set of activities in the video game can be played, or how a set of mechanics in an activity can be used to play the activity. A mechanic generally represents at least one of a set of tools, a set of capabilities, or a set of skills available to play an activity or a portion of an activity. Another example of video content includes a video file generated by one of the video game player devices and uploaded to the third party system 190 directly or through the video game platform 190, where the video file records the game play of a video game player operating the video game player device. Likewise, a similar video file can be uploaded to the third party system 190 from the video game console 110.

In an example, the video game player devices 130 represent computing devices of video game players that may, but need not, include the user 112. Similar functionalities can be provided on each one of the video game player devices and the video game console 110.

In an example, the video game developer system 170 represents a computer system that includes a set of computing resources for developing video games and available to a video game developer. In particular, the video game system 170 can store video game software 172, upload such software 172 to the video game platform 150, and/or download such software 172 to the video game console 110.

The video game software 172 of a video game may include source code, data, assets, and other resources which, once compiled into a program and executed by an appropriate computing device, cause the computing device to present video game content of the video game. The video game software 172 may include source code, assets, and other resources for various categories and/or types of video game content 122 that are common to all video games and/or similar types of video games. As described herein, video game content 122 may refer, in the abstract, to the various components of a video game that can be perceived by a user as they interact with the video game. Examples of common types of video game content include actors, activities, mechanics, zones, and the like, as described further herein. The video game software 172 includes visual, audio, and other assets, such as 3D models, animations, audio files, or the like, that define how respective components of the video game content will be visually or auditorily perceived through a user interface, such as a display or speaker.

The video game software 172 also includes source code that logically controls how the respective components of the video game content interact with each other and respond to user inputs. This source code may include game logic, physics calculations, artificial intelligence routines, and other functional components that define the behavior of the game elements. For instance, the code may govern how a character moves, how game mechanics such as jumping or shooting are executed and the effect they have, and how NPCs react to player actions.

In addition, the code may define the available game states and/or combinations of game states, as well as how and/or when a user is able to modify the game state. As described herein, a video game state may refer to the specific condition or status of a video game at a particular point in time, and may encompass all of the dynamic aspects of the game, including the positions and statuses of characters, the current level or stage of a player or character within the game, the score, inventory items, environmental conditions, or other variable elements that define the game's progress and interactions given the preceding interactions and/or inputs of a user with the video game.

In an example, the third party system 190 represents a computer system, such as one or more content servers, for providing video content 192 to the video game console 110 directly or indirectly through the video game platform 150. As explained herein above, the video content 192 can include video files demonstrating how a video game can be played, a set of activities in the video game can be played, or a set of mechanics in an activity can be used to play the activity. The video content 192 can be uploaded to the third party system 190 from the video game developer system 170, the video game console 110, and/or one or more of the video game player devices 130 directly or indirectly through the video game platform 150.

In an example, the video game platform 150 represents a computer system that provides various video-game related functionalities to the video game console 110. For instance, the video game platform 150 is set-up as a hub between the video game console 110, the video game player devices 130, the video game developer system 170, and third party system 190. In particular, the video game software 172 and the video content 192 can be downloaded to the video game consoler 110 through the video game platform 150. An instance of a video game based on video game software stored on the video game platform 150 can be instantiated for the video game console 110. A video file can be streamed through the video game platform 150 to the video game console 110. And communications data (e.g., messages, commands, etc.) can be exchanged between the video game console 110 and the video game player devices 130 through the video game platform 150.

In an example, the video game platform 150 receives content metadata 176 for video games developed by video game developers, such as the video game developer 170. Content metadata 176 may include definitions for individual and/or discrete instance of game content available within a video game. There may be one or more types of content metadata 176. The types of content metadata may correspond to the common types of content within video games, such as activities, actors, mechanics, zones, or the like, as further described above. Each type of content metadata may include one or more fields and/or attributes that are common to that particular type of content, as described further herein.

In an example, the video game platform 150 receives content event definitions 174 for the content in video games developed by various video game developers, such as the video game developer 170. Content event definitions 174 may include definitions for individual instances of events and/or actions that can occur in relation to a corresponding instance of game content during execution of a video game. Content event definitions 174 may include one or more types of event definitions. The types of content event definitions may correspond to the common types of events and/or actions that occur within video games in relation to corresponding types of game content. Each type of content event definition may include one or more fields and/or attributes that are common to that particular type of event, as described further herein. In some embodiments, content event definitions include one or more fields and/or attributes for derived data, such as network configurations.

In an example, the video game developer system 170 receives templates 151 for the content metadata 176 and content event definitions 174 from the video game platform 150.

Templates 151 may include predefined templates for the different types of game content.

Predefined templates for the different types of game content may define the one or more fields and/or attributes for which values are necessary and/or optional when defining a particular instance of game content. Templates 151 may include predefined templates for the different types of events and/or actions that occur within video games in relation to corresponding types of game content. predefined templates for the different types of events and/or actions that occur within video games may define the one or more fields and/or attributes for which values are necessary and/or optional when defining a particular instance of an event for a corresponding instance of game content.

Generally, and as described above, an activity is a unit of game play inherent to the structure of a video game. Different categories of activities exist including progress activities, competitive activities, challenge activities, and open ended activities. While described as activities, other methods of defining units of gameplay that are discrete and distinguishable within the structure of a video game are possible. The one or more fields and/or attributes in the content metadata for an activity may include an activity identifier, a name, and a category. The activity identifier is a unique identifier of the activity. Corresponding event definitions may refer to the activity identifier. The name can be a short, localized name of the activity. Other properties are possible including, for instance, a description (e.g., a longer description of the activity), an image of the activity, a default availability (e.g., whether the activity is available to all video game players before launching the video game), whether completion of the activity is required to complete the video game, whether the activity can be played repeatedly in the video game, and nested Tasks (child activities, also referred to herein as sub-activities). Multiple types of event definitions for activities are possible.

An example of an event about an activity can indicate changes in activity availability for a video game player (e.g., the user 112). This is primarily used to decide what activities to display and to remove spoiler block for those activities (where an activity having a spoiler may not be surfaced to the video game player). A property of this event may include, for instance a list (e.g., array) of activities that are currently available.

An example of an event about an activity can indicate that a video player is currently participating in the activity or task (e.g., a child activity). A property of this event may include, for instance the activity identifier of the activity. Another property can optionally be a time corresponding to the start of the participation in the activity.

An example of an event about an activity can indicate the end of the activity or task (e.g., a child activity). A property of this event may include, for instance the activity identifier of the activity. Another property can optionally be a time corresponding to the end of the participation in the activity. Yet another property can optionally be an outcome of the activity, such as completed, failed, or abandoned.

As described above, a zone may represent an area of a game world of the video game (e.g., a virtual world) with a single coordinate system. A zone may have a two-dimensional (2-D) map image associated with it, used to display locations on the zone. The one or more fields and/or attributes in the content metadata for zones may include a zone identifier and a name. The zone identifier is a unique identifier of the zone. The name can be a short localizable name of the zone. Other properties are possible including, for instance, an indication of whether the object should be treated as hidden for spoiler block uses cases (the default may be set to false), a map (e.g., a high resolution image for the zone 2-D map), a view projection (e.g., a matrix (4×4) to convert from three-dimensional (3-D) work coordinates to 2-D map position), and an image (e.g., a display image for the zone if different from the map). Multiple types of events about zones are possible.

An example of an event about a zone can indicate an update to the current in-game location of the video game player. This event can be reported regularly, or whenever the player's in-game location changes significantly. A property of this event includes the zone identifier.

Other properties are possible, such as optionally position (e.g., x, y, z position of the video game player character (the virtual player of the video game player) in the zone) and orientation (e.g., x, y, z vector indicating the video game player character's direction).

Another example of an event about a zone can indicate the video game player's zone, location, and orientation, at the time of starting an activity. This event can enable location-based help. A property of this event includes the activity identifier. Other properties are possible, such as optionally the zone identifier and the position and orientation of video game player's character in the video game.

Yet another example of an event about a zone can indicate the video game player's zone, location, and orientation, at the time of ending an activity. This event can also enable location-based help. A property of this event includes the activity identifier. Other properties are possible, such as optionally the outcome of the activity, the zone identifier, and the position and orientation of video game player's character in the video game.

As described above, an actor represents an entity with behaviors in the video game. The actor can be player-controlled or game-controlled, and this can change dynamically during game play. The one or more fields and/or attributes in the content metadata for an actor can include an actor identifier and a name. The actor identifier is a unique identifier of the actor. The name can be a localizable name of the actor. Other properties are possible including, for instance, an indication of whether the object should be treated as hidden for spoiler block uses cases (the default may be set to false), an image of the actor, and a short description of the actor. Multiple events about actors are possible.

An example of an event about actor(s) can indicate that a change to the video game player's selection of actor(s). Selected actors represent the actors the video game player is controlling in the video game, and can be displayed on the video game player's profile and other presentation spaces. There can be more than one actor selected at a time. The video game should replace the list of actors upon loading save data. A property of this event includes a list (e.g., array) of actors which are currently selected by the video game player.

Generally, and as described above, a mechanic represents an item (e.g., tool), capability, skill, or effect that can be used by video game players or the video game to impact game play (e.g. bow, arrow, stealth attack, fire damage). Mechanics generally exclude items that do not impact game play (e.g. collectibles). The one or more fields and/or attributes in the content metadata for a mechanic can include a mechanic identifier and a name. The mechanic identifier is a unique identifier of the mechanic. The name can be a short localizable name of the mechanic. Other properties are possible including, for instance, an indication of whether the object should be treated as hidden for spoiler block uses cases (the default may be set to false), an image of the mechanic, and a short description of the mechanic. Multiple events about mechanics are possible.

An example of an event about a mechanic can indicate that the mechanics available to a video game player have changed. Availability of a mechanic represents that the mechanic is available in the game world for the video game player to use, but may necessitate the video game player to go through some steps to acquire it into inventory (e.g. download from a store, pick up from the world) before using it. This event can also be used to indicate lifting of spoiler block on the mechanic object, and to filter help tips to avoid suggesting use of a mechanic that is unavailable. The video game should replace the list of mechanics upon loading save data. A property of this event includes a list (e.g., array) of mechanics which are currently available.

Another example of an event about a mechanic can indicate that a video game player's inventory has changed. Inventory refers to mechanics that are immediately usable to the video game player without having to take additional steps in the video game before using it. Inventory information can be used to estimate a player's readiness for an activity. The video game should replace the list of inventory upon loading save data. A property of this event includes a list (e.g., array) of mechanics which are currently in inventory.

Yet another example of an event about a mechanic can indicate that a video game player's load out has changed. Load out represents the mechanics that are most immediately accessible to the video player, and is the subset of inventory which is displayable to the video game player. The video game should replace the list of mechanics upon loading save data. A property of this event includes a list (e.g., array) of mechanics which are now part of the active load out.

A further example of an event about a mechanic can indicate that the mechanic has been used by or against a video game player. Properties of this event include a list (e.g., array) of mechanics which were used (e.g. fire arrow, fire damage) and whether the mechanics were used by or against the video game player. Other properties are possible, such as optionally an initiator actor identifier (e.g., an identifier of the actor that initiated the use of the mechanic), a zone identifier of the initiator actor, and a position of the initiator actor.

Another example of an event about a mechanic can indicate that the mechanic had an impact on game play (e.g. an arrow hit a target). Properties of this event include a list (e.g., array) of mechanics which were used (e.g. fire arrow, fire damage) and whether the mechanics were used by or against a video game player. Other properties are possible, such as optionally the initiator actor identifier, the zone identifier of the initiator actor, the position of the initiator actor, a target actor identifier (e.g., an identifier of the actor targeted by the mechanic), a zone identifier of the target, a position of the target actor, and an identifier of a mechanic that mitigates the initiator's mechanic(s).

As described above, game media represents a piece of media (text, audio, video, image) related to the video game. Game media may be provided by the game developer as a pre-rendered piece of media and/or algorithmically generated, such as a piece of media rendered by an in-game engine. The game media may exist in-game (e.g. cut-scene, audio log, book) or may not (e.g. developer commentary). The one or more fields and/or attributes in the content metadata for a piece of game media may include a game media identifier, a name, a format, a category, an unlock rule, and a uniform resource locator (URL). The game media identifier is a unique identifier of the game media. The name can be a localizable name of the game media.

The format can indicate the media format, such as whether the game media is an image, audio, video, text, etc. The category indicates a type of the game media, such as whether the game media is a cut-scene, audio-log, poster, developer commentary, etc. The unlock rule indicates whether the game media should be unlocked for all video game players or based on an activity or a specific game media event. The URL references a server-provisioned media file, where this server can be part of the game developer system 170 or the video game platform 150. Other properties are possible including, for instance, an indication of whether the object should be treated as hidden for spoiler block uses cases (the default may be set to false), an entitlement (e.g., indicating that only video game players who own a particular video game entitlement can unlock the game media), and an activity identifier (e.g., to associate the game media with a particular activity). Multiple events about game media are possible.

An example of an event about game media can indicate that a particular piece of game media has been unlocked for a video game player. A property of this event includes the game media identifier.

Another example of an event about game media can indicate that a particular piece of game media has started in the video game. The game media object should be considered unlocked for the video game player at the corresponding time. A property of this event includes the game media identifier.

Yet another example of an event about game media can indicate that a particular piece of game media has ended in the video game. A property of this event includes the game media identifier.

In an example, the video game software 172 includes instrumentation to generate events corresponding to each event in the content event definitions 174 upon execution of the instrumentation by a respective device. The instrumentation to generate the events may be included in the portions of the program code that effect, or otherwise bring about, a change in game state for a player in relation to a particular instance of game content. For example, the instrumentation to generate an instance of an “activity start” event corresponding to a content event definition for a particular activity may be included in the program code responsible for loading the objectives for the activity, preparing the NPCs involved in the activity, and/or display an activity introduction to the player.

In an example, the universal content engine 178 represents one or more applications and/or services executed by the video game developer system 170 to generate the content metadata 176, content event definitions 174, and/or associated instrumentation from the video game software 172. For instance, the universal content engine 178 may analyze the source code, data, assets, and other resources for a video game to identify instances of various types of game content, as well as events that may occur in relation to the identified instances of the game content, as described further herein. The universal content engine 178 may identify and generate the instances of the game content and their associated events based on the templates 151 from the video game platform 150. Furthermore, the universal content engine 178 may generate the instrumentation within the video game software 172 that generates the event data upon execution of the video game software 172.

In an example, the universal content engine 178 generates the content metadata 176, content event definitions 174, and/or instrumentation autonomously and/or semi-autonomously. For example, the universal content engine 178 may include one or more tools and/or interfaces that allow a video game developer to review and/or modify the identified instances of the content metadata 176, the content event definitions 174, and/or the instrumentation, as described further herein.

In an example, the universal content engine 158 represents one or more applications and/or services executed by the video game platform 150 to generate the content metadata 176, content event definitions 174. For example, the universal content engine 158 may analyze the executable program code, and/or the effects of executing the program code, to identify instances of various types of game content, as well as events that may occur in relation to the identified instances of the game content, as described further herein. Furthermore, the universal content engine 158 may generate instrumentation that generates the event data upon execution of the video game software 172.

Upon execution of the instrumentation for a particular content event definition by a respective computing device, an instance of event data according to the particular content event definition may be generated. For example, and as illustrated, event data 114 may be generated upon execution of the instrumentation by the video game console 110 and event data 132 may be generated upon execution of the instrumentation by each the respective video game player devices 130.

In an example, the video game platform 150 receives the event data 114 from the video game console 110 and event data 132 from the video game player devices 130 and stores such received data in a data store 152 as event data 154. An event processor 156 of the video game platform 150 processes the event data 154 to provide video-game related functionalities and/or services that enable the video game console 110 and/or the video game player devices 130 to provide a uniform experience for interacting with game-related content, as described above, for different video games. For example, the video game platform 150 may generate and send any of an activity time estimation 162, an activity suggestion 164, and an activity help 166 to the video game console 110 for presentation on the display 120.

The activity time estimations 162 represents estimated lengths of time to complete activities in one or more video games, which may be referred to herein as completion times. The activity suggestions 164 represents information suggesting activities available to the user 112 in the one or more video game and not previously performed or completed by the user 112. The activity help 166 may include information, such as a video file, textual description, and/or a graphical description about completing an activity in video game or using a mechanic in at least a portion of the activity.

The event processor 156 may execute logic that, for instance, performs a statistical analysis across a subset of the event data 154 associated with a particular activity to generate an estimated completion time for the particular activity, a suggestion to complete the particular activity, and/or information that could help players complete the particular activity. In addition, the processor 156 can execute logic that customizes any of the activity time estimations 162, the activity suggestions 164, or the activity help 166 based on the event data 114 from the video game consol 110 that is indicative of a current game state in the video game for the user 110 and/or that is indicative of one or more user-specific factors, such as the user's level of experience, playing style, and/or past performance in similar activities. This customization ensures that the assistance provided is tailored to the individual user, enhancing their gameplay experience and increasing the likelihood of successfully completing activities.

In an example, the event processor 156 may aggregate in-game accomplishments (e.g., successful completions of activities) achieved by a particular player across multiple video games for display in a trophy interface. In yet another example, the event processor 156 may collect information about the successful completions of a particular activity by a plurality of players in order to help a subsequent player determine how to complete the activity, such as by providing recorded video of the successful completions by the previous players who completed the activity, information about what mechanics the previous players used to complete the activity, where within the game world the previous players were when they completed the activity, or the like.

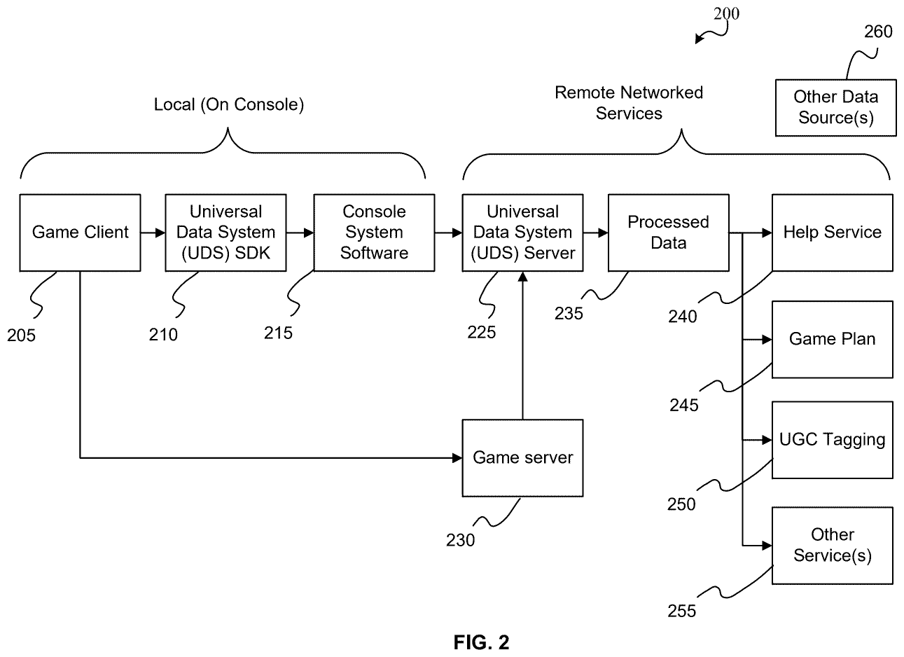

FIG. 2 illustrates an example of a system architecture for providing game-related content and services to users in a uniform manner across video games, according to embodiments of the present disclosure. In some embodiments, the exemplary system architecture 200 includes a game client 205, a universal data system (UDS) software development kit (SDK) 210, console system software 215, a UDS server 225, a game server 230, processed data 235, and one or more other remote networked services, including a help service 240, game plan 245, user generated content (UGC) tagging 250, and other service(s) 255. The help service 240 may also receive information from other data source(s) 260. Some of the components of the system architecture 200 are examples of components of the video game platform 150 of FIG. 1. For instance, the UDS server 225 and the game server 230 are components of the video game platform 150.

The game client 205 and game server 230 provide contextual information regarding at least one application to a universal data system (UDS) server 225 via a UDS data model describing the logical structure of UDS data used by the UDS SDK 210. As described herein, contextual information regarding a video game application may include game state information for a respective execution of the video game application, including events that occur in relation to instances of game content, as described above. The UDS data model enables the platform (e.g., the video game platform 150) to realize remote networked services, such as the help service 240, game plan 245, UGC tagging 250, and other service(s) 255 that require game data, without requiring a game to be patched separately to support a service. The UDS data model assigns contextual information to the various types game content in a unified way across games. The contextual information from the game client 205 and UDS SDK 210 is provided to the UDS server 225 via the console system software 215. It is to be understood that the game client 205, UDS SDK 210, and console system software 215 may run on a computer or other suitable hardware for executing at least one application.

The UDS server 225 receives and stores contextual information from the game client 205 and game server 230 from at least one application. To be sure, the UDS server 225 may receive contextual information from a plurality of game clients and game servers for multiple users. The UDS server 225 may also receive data from other systems and components, such as user identifiers, localization data, or the like. The information may be uniformly processed 235 and then received by the plurality of remote networked services 240, 245, 250, and 255.

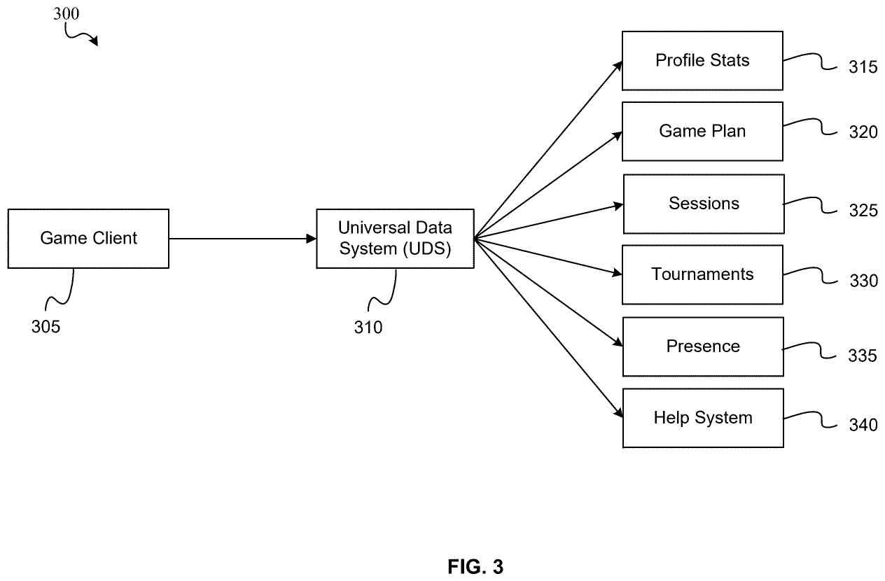

FIG. 3 illustrates another example of a system architecture 300, according to embodiments of the present disclosure. A game client 305 sends contextual information to a UDS server 310, which provides the contextual information in a unified data model to a plurality of remote networked services, including profile stats 315, game plan 320, sessions 325, tournaments 330, presence 335, and help system 340.

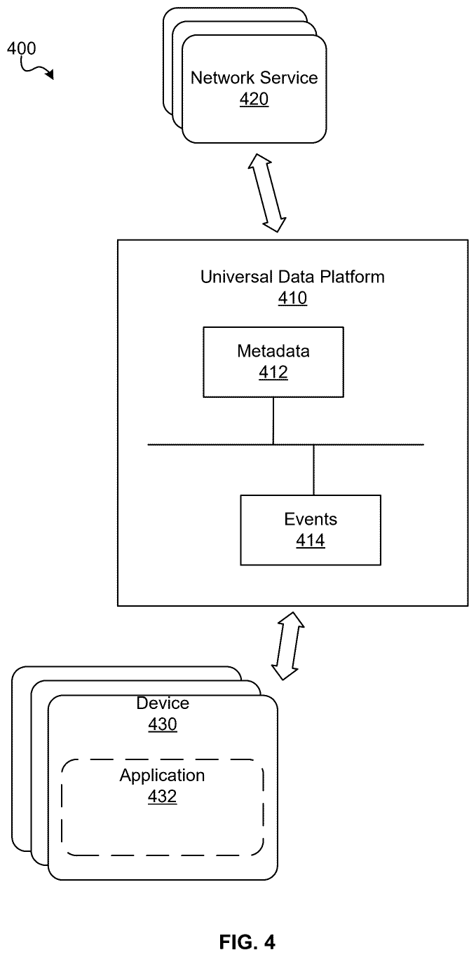

FIG. 4 illustrates an example of a system 400 for providing a data model for a universal data platform 410, according to embodiments of the present disclosure. Some of the components of universal data platform 410 are examples of components of the video game platform 150 of FIG. 1. In one example embodiment, system 400 can include at least one device 430 configured to execute at least one of a plurality of applications 432, each application having an application data structure. The universal data platform 410 can be executed on one or more servers. The universal data platform 410 can include a data model which is uniform across the plurality of application data structures. The data model can include metadata 412 corresponding to at least one object indicated in the data model, and events 414 corresponding to a trigger condition associated with at least one metadata entry. The values of the metadata 412 and events 414 can be associated with a user profile. The universal data platform 410 can be configured to receive application data from the at least one device 430 and store the application data within the data model. The system 400 can also include a plurality of remote networked services 420 configured to access the application data from the universal data platform 410 using the data model.

In various embodiments, and as described above in relation to content metadata 176, the metadata 412 may include: a list of all activities that a user can do in an application, an activity name, a description of the activity, a state of the activity (whether available, started, or completed), whether the activity is required to complete an objective or campaign, a completion reward for the activity, an intro or outro cut-scene, an in-game location, one or more conditions that must be met before the activity becomes available, and a parent activity that contains the activity as a sub-activity. Metadata 412 may further include: a list of abilities exercisable by a user, effects of each action, telemetry indicative of when actions and effects take place including corresponding timestamps and locations, an in-game coordinate system, a list of in-game branch situations, and telemetry indicative of when a branch situation is encountered and which option is selected by the user. A list of in-game statistics, items, lore, in-game zones and corresponding attributes regarding each statistic, item, lore, or zone may likewise be included in the metadata 412. In addition, the metadata 412 may indicate whether or not a particular activity, entity (such as a character, item, ability, etc.), setting, outcome, action, effect, location, or attribute should be marked as hidden.

As further described above in relation to content event definitions 174, event data 114, and/or event data 132, events 414 may be fired in response to several various trigger conditions. For example, such trigger conditions may include: an activity that was previously unavailable becomes available, a user starts an activity, a user ends an activity, an opening or ending cut-scene for an activity begins or ends, the user's in-game location or zone changes, an in-game statistic changes, an item or lore is acquired, an action is performed, an effect occurs, the user interacts with a character, item, or other in-game entity, and an activity, entity, setting, outcome, action, effect, location, or attribute is discovered. The events 414 may include further information regarding a state of the application when the events 414 were triggered, for example a timestamp, a difficulty setting and character statistics at the time a user starts or ends an activity, success or failure of an activity, or a score or duration of time associated with a completed activity. It is to be understood that metadata 412 and events 414 may include any and all contextual information related to activities described in the present disclosure.

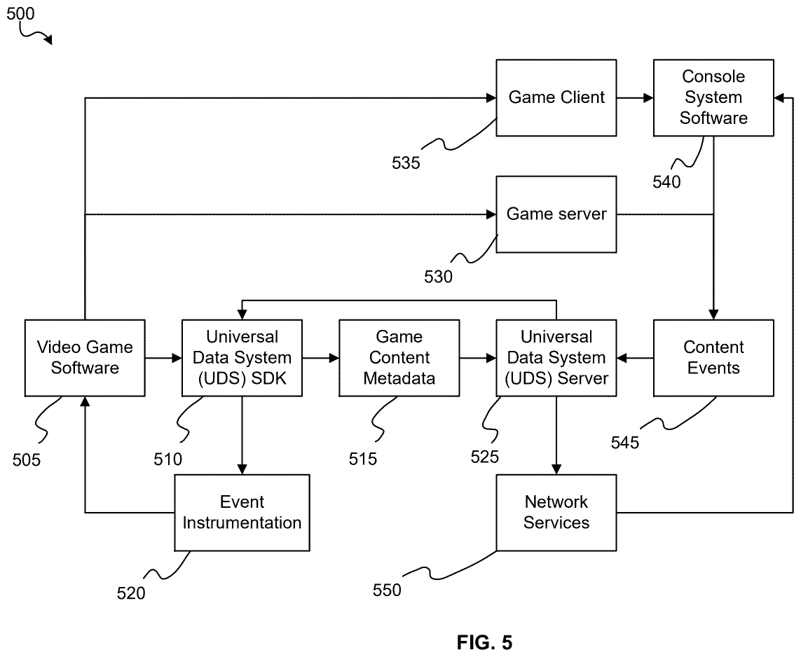

FIG. 5 illustrates another example of a system architecture for providing game-related content and services to users in a uniform manner across video games, according to embodiments of the present disclosure. In some embodiments, the exemplary system architecture 500 includes: video game software 505; a universal data system (UDS) software development kit (SDK) 510; content state triggers 515; game content metadata 515; a UDS server 525; a game server 530; a game client 535; console system software 540; content events 545; and network services 550. Some of the components of the system architecture 500 are examples of components of the video game platform 150 of FIG. 1. For instance, the UDS server 525 and the game server 530 are components of the video game platform 150. Some of the components of the system architecture are examples of components of the video game developer system 170 of FIG. 1. For instance, the UDS SDK 510 may be an example of the universal content engine 178. Additionally, or alternatively, the UDS SDK 510 may be remotely accessible from the video game developer system 170 and/or the video game platform 150 (e.g., running on a cloud-based server system).

The UDS SDK 510 may analyze the video game software 505 to identify instances of game content. For example, the UDS SDK 510 may analyze the underlying source code to identify one or more files that define an actor object, an activity object, a mechanic object, a zone object, or the like; determine to which type of game content the objects correspond; and generate instances of game content metadata 515 for each unique instantiation of the object within the video game software 505. As another example, the UDS SDK 510 may examine game assets like 3D models, textures, and sound files to identify and catalog visual and audio elements associated with specific game zones, actors, activities, and/or mechanics.

As described further herein, each instance of game content metadata 515 may include values for one or more attributes that are common to the corresponding type of game content.

The UDS SDK 510 may identify the values for the one or more attributes from an analysis of code used to define and/or instantiate a particular instance of game content. For example, the UDS SDK 510 may identify a variable titled “name” in an instantiation of an object and use the value of the variable as the value for a “name” attribute in the corresponding instance of the game content metadata 515.

The UDS SDK 510 may further analyze the video game software 505 to identify instances of events that may occur in relation to the identified game content. The UDS SDK 510 can identify functional components of the source code that act on the identified game content objects; determine whether the functional components correspond to a type of event that commonly occurs to the corresponding type of game content, and if so, to which type of event the functional components correspond; identify instances where the functional components are invoked in relation to an identified instance of game content; and generate corresponding event definitions, as described above, in the game content metadata 515 for each unique invocation.

To illustrate, consider one or more software resources that define a class of objects, such as a tire class. The UDS SDK 510 may identify the one or more software resources and determine that they correspond to a type of mechanic in the video game. The UDS SDK 510 may further identify unique instantiations of the tire class, such as an instantiation for a “slick” tire and an instantiation of a “wet” tire, as unique instances of the mechanic, and generate corresponding instance of the game content metadata 515. The values for each instance of the game content metadata 515 may be based on the values used to instantiate each instance of the tire class and/or the values of one or more properties of the tire class that are set during instantiation.

Subsequently, the UDS SDK 510 may identify a vehicle object that includes, as a property, the tire class, and/or a method that modifies the tire property of a vehicle object, and determine that updates to the tire property correspond to the general action or event within video games of using or equipping an actor (which may be a vehicle in this case) with a mechanic. Based on the identification of a method that updates the property, for example, the UDS SDK 510 may generate an event definition for each instance of the game content metadata 515 corresponding to the “slick” tire and the “wet” tire.

As further illustrated, the UDS SDK 510 may generate event instrumentation 520. As described further above, event instrumentation 520 may include functional code that causes the video game software 505 to generate and/or transmit content events 545 according to an event definition when the code is executed by the game server 530 and/or game client 535. For instance, and continuing with the previous example, the UDS SDK 510 may generate source code for incorporation within the method that updates the tire property of the vehicle object so that, when the method is executed by to equip a vehicle with the “slick” tires, the additional source code will be executed by the game client 535 to generate a content event according to the event definition for the “slick” tires, which can be observed by the console system software 540 and transmitted to the UDS server 525.

In an example, the UDS SDK 510 includes one or more machine learning (ML) models trained to identify instances of game content, as well as the events that may occur in relation to the instances of game content, and generate the corresponding game content metadata 515. For example, the ML models within the UDS SDK 510 may be trained using a dataset of annotated game code and assets from various video games for which game content metadata has already been generated and/or verified. These models can learn to recognize patterns and features associated with different types of game content and events. For example, the models may be able to identify an actor object by recognizing specific naming conventions, inheritance structures, or property definitions in the code. Similarly, they can detect events by identifying code segments that manipulate game state variables or invoke specific functions under certain conditions.

The ML models can also be continuously updated and refined by incorporating new data from additional games, improving their accuracy and adaptability over time. This allows the UDS SDK 510 to stay current with evolving game development practices and new types of game content and events. Furthermore, the UDS SDK 510 may include tools for game developers to manually verify and/or modify the automatically generated game content metadata 515 and event definitions. The UDS SDK 510 may further incorporate a feedback loop that retrains the ML models based on the manual verifications and/or modifications. This ensures that the generated metadata and event definitions accurately reflect the intended game design and logic.

In an example, the UDS SDK 510 includes one or more ML models trained to generate the event instrumentation 520 and/or incorporate the event instrumentation 520 within the video game software 505. For example, the ML models may analyze the game code to identify where and how to insert the event instrumentation 520. These models might look for specific patterns in the code that indicate the execution of game events, such as function calls, state changes, or user interactions. Once identified, the models can generate the code to instrument these events.

For instance, if the game code includes a function that handles the player's interaction with an in-game object, the ML model could generate and insert additional code that logs this interaction as an event. This might involve creating a new log entry, sending data to a remote server (e.g., to the UDS server 525), or updating a local database with information about the event. The ML models can also be trained to understand the context of the game code, ensuring that the event instrumentation is inserted in a way that does not interfere with the game's performance or logic. This might involve analyzing the game's execution flow, resource usage, and potential side effects of the instrumentation code. Furthermore, the UDS SDK 510 may provide a developer interface that allows game developers to review and customize the automatically generated event instrumentation. Developers can use this interface to fine-tune the instrumentation, ensuring it aligns with their specific requirements and game design.

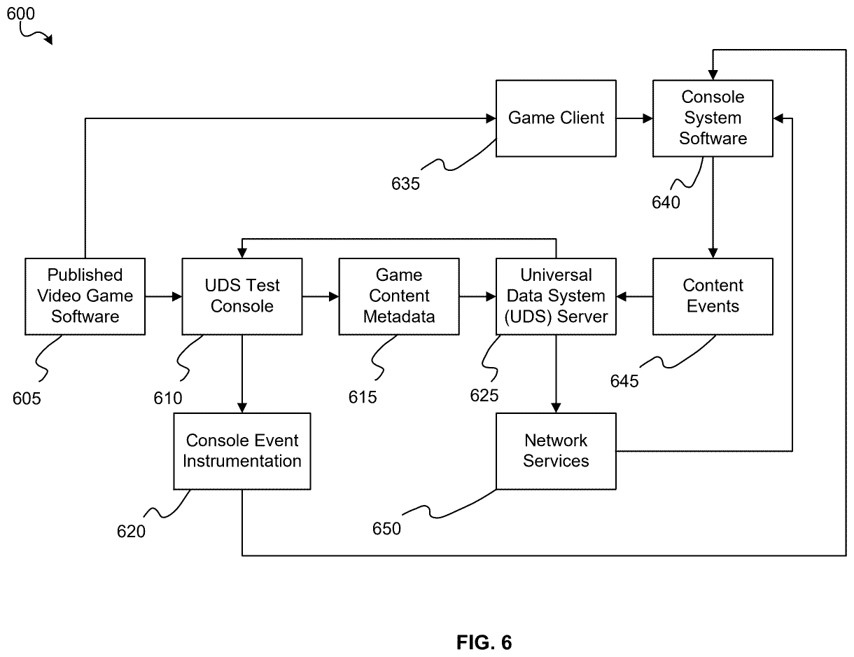

FIG. 6 illustrates another example of a system architecture for providing game-related content and services to users in a uniform manner across video games, according to embodiments of the present disclosure. In some embodiments, the exemplary system architecture 600 includes: published video game software 605; UDS test console 610; game content metadata 615; console event instrumentation 620; a UDS server 625; a game client 635; console system software 640; content events 645; and network services 650. Some of the components of the system architecture 600 are examples of components of the video game platform 150 of FIG. 1. For instance, the UDS server 525 and the UDS test console 610 may be components of the video game platform 150.

In an example, the UDS test console 610 represents one or more physical and/or virtual machines that emulate the functionality of a game console, such as video game console 110, or other video game player devices. Additionally, or alternatively, the UDS test console 610 may include one or more applications and/or services that emulate the execution of the console system software 640 by such devices. The UDS test console 610 may further include one or more applications and/or services that monitor the physical and/or virtual computing resources that are being emulated, such as processor usage, memory consumption, network bandwidth, graphics buffers, storage I/O, or the like. Further, the UDS test console 610 may include one or more applications and/or services that can simulate execution of the published video game software 605 by the console system software 640. Additionally, or alternatively, the UDS test console 610 may include one or more applications and/or services that can simulate interactions within the video game.

During execution of the published video game software 605, the UDS test console 610 may monitor the physical and/or virtual computing resources and/or the simulation of the console system software 640, to identify instances of game content, as well as the events that may occur in relation to the instances of game content, and generate the corresponding game content metadata 615. For example, the UDS test console 610 may monitor memory consumption by the physical and/or virtual machines to identify spikes or patterns in usage that correspond to the beginning and end of an activity within the video game. Additionally, the UDS test console 610 can monitor CPU and GPU utilization to detect when significant processing events occur, such as loading new game levels or initiating complex animations. Network bandwidth usage can also be tracked to identify online multiplayer events or downloads that start and finish during gameplay. As another example, the UDS test console 610 may monitor simulated user inputs via a game console controller to identify patterns of input that correspond to interactions with different types of game content.

The UDS test console 610 can also analyze the output graphics and audio of the published video game software 605 to identify values for the game content metadata 615 corresponding to the identified instances of game content. This analysis involves capturing and processing visual and auditory data generated during gameplay. For example, the UDS test console 610 can utilize computer vision techniques to analyze frame-by-frame video output, identifying specific visual elements such as characters, objects, environments, and user interface components. This can include recognizing unique visual markers or patterns that correspond to particular game activities, zones, or mechanics.

Similarly, the UDS test console 610 can employ audio analysis algorithms to detect and categorize various sounds, music, and voiceovers within the game. By analyzing audio frequencies, waveforms, and spectrograms, the system can identify distinct audio cues associated with game events, such as the start of a quest, the completion of an objective, or interactions with non-playable characters (NPCs). The combination of visual and audio data provides a multi-dimensional understanding of the game content, allowing the UDS test console 610 to generate comprehensive metadata that includes values for the identified instances of game content. For instance, the system can correlate the appearance of a specific visual element, like a character entering a new zone, with an audio cue, such as a change in background music, to accurately determine the beginning of a new activity.

As further illustrated, the UDS test console 610 may generate console event instrumentation 620. Console event instrumentation 620 may include code snippets and logging mechanisms that are embedded within the console system software 640. These components are designed to capture and report events in real-time based on the detected resource patterns and output graphics/audio used to identify the instances of the game content and the corresponding events that may occur in relation thereto. When the game client is executed, the console system software 640 utilizes the console event instrumentation 620 to accurately log and transmit content events 645 to the UDS server 625.

In an example, the UDS test console 610 includes one or more ML models trained to identify instances of game content, as well as the events that may occur in relation to the instances of game content, and generate the corresponding game content metadata 615. For example, the ML models within the UDS test console 610 may be trained using a dataset of annotated telemetry data, such as game logs, player interactions, and performance metrics from the executions of various video games. These models can learn to recognize patterns and features associated with different types of game content and events. For example, the models may be able to identify an activity by recognizing specific sequences of player actions, the presence of particular visual and audio cues that are typically associated with the start, progression, and completion of an activity, or the like.

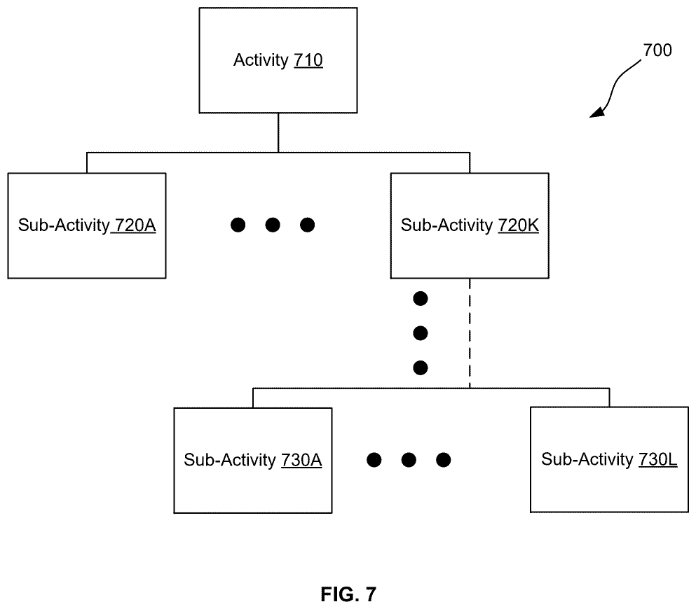

FIG. 7 illustrates an example of an activity hierarchy, according to embodiments of the present disclosure. As illustrated, an activity 710 can include multiple nested tasks, referred to herein as sub-activities, forming a hierarchy 700. The activity 710 can be a node on top of the hierarchy 700 (e.g., a root node) and can have a set of child sub-activities 720A-720K at the next level of the hierarchy 700. In turn each ones of the sub-activities 720A-720K may be a child node of the activity 710 and, possible, a parent node to a set of sub-activities at the next hierarchy level. For instance, the sub-activity 720K is a parent node to a set of sub-activities 730A-730L. This type of association between nodes, each representing a sub-activity, can be repeated at the different levels of the hierarchy 700. A set of mechanics can be associated with each node indicating that such mechanic(s) can be available or usable in the activity corresponding to the node.

As explained herein above, the activity 710 has an activity identifier. Each sub-activity also represents an activity and, thus, has an activity identifier too. Likewise, each of the mechanics has a mechanic identifier. Associations between the activity identifiers themselves and between the activity identifiers and the mechanic identifiers can be defined based on the hierarchy 700. Such associations can be stored in objects that define the activities (or sub-activities) and/or that define the mechanics and/or can be stored in events that relate to such objects. For instance, the activity identifier of the sub-activity 720K can be associated with the activity identifier of the activity 710 and/or the activity identifiers of the sub-activities 730A-730L. Similarly, the activity identifier of the sub-activity 730L can be associated with the activity identifier of the sub-activity 720L and/or the mechanic identifiers of the mechanics 740A-740M. Further, a mechanic identifier of a mechanic can be associated with an activity identifier.

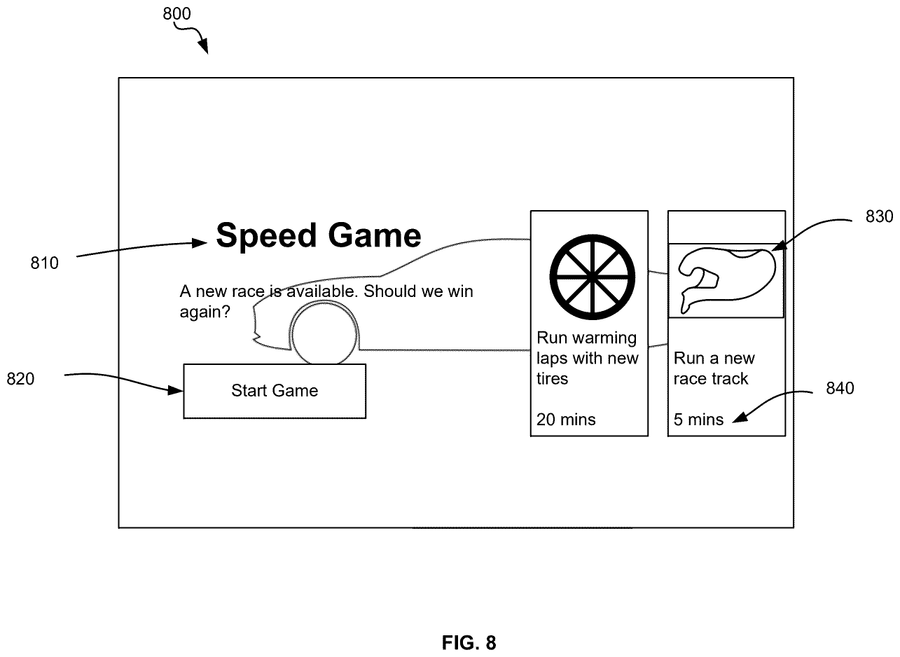

FIG. 8 illustrates an example of a user interface for presenting information about an estimated length of time for completing an activity, according to embodiments of the present disclosure. In particular, a video game console (e.g., the video game console 110 of FIG. 1) presents video game-related functionalities to a user of a video game (e.g., the user 112 of FIG. 1). In addition to enabling game play, the game-related functionalities present the estimated length of time (e.g., estimated completion time) for the activity. User input can be received to launch the activity following the presentation of its estimated completion time.

As illustrated in FIG. 8, the video game console presents a user interface 800 on a display (e.g., the display 120 of FIG. 1). The user interface 800 includes a video game page that shows various information and functionalities that relate to a video game. In an example, a short description 810 of the video game is presented (e.g., game title, the developer, an edition of the video game). A selectable option 820 to start the video game is also presented. Other information and functionalities are also possible.

In addition, a set of activity suggestions 830 is presented. Each one of the activity suggestions 830 can be presented in a window, an icon, an overlay, or any other graphical user interface element within the user interface 800. An activity suggestion can identify an activity in the video game, where the activity is available to the user and not previously attempted or completed by the user. For instance, the activity suggestion includes a textual description and an image of the activity, where such data is available from the object that defines the activity.

Further, the activity suggestion includes an estimated completion time 840 for the activity (e.g., shown as twenty minutes for the first suggested activity about running warming laps with new tires and as five minutes for the second suggested activity about running a new racetrack). The estimated completion time 840 can be generated from event data association with the activity, where the event data is collected from a plurality of video game devices and for a plurality of video game players that have played the activity.

A user selection of a suggested activity can trigger the video game console to launch the activity (e.g., locally or remotely based on an instance of the video game on the video game platform). Video game content related to the activity can be presented in the user interface 800.

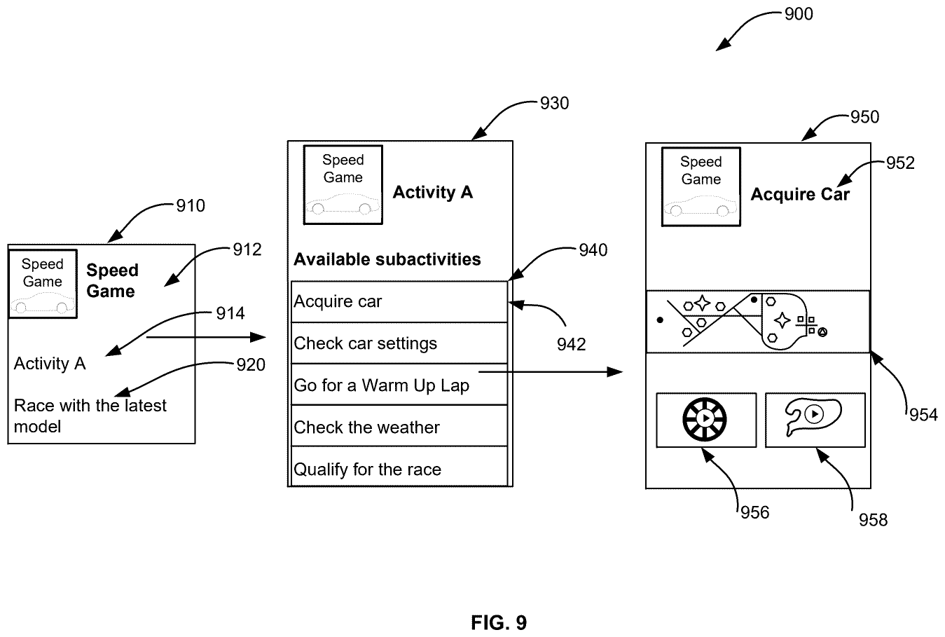

FIG. 9 illustrates an example of displaying video game help through a user interface 900, according to embodiments of the present disclosure. Initially, the user interface 900 presents an activity card 910 for an activity. Upon a user interaction with the activity card 910, the user interface 900 presents an expanded activity card 930 showing sub-activities of the activity. Upon a user selection of a sub-activity, the user interface 900 presents a help card 950 that includes a map of a zone showing a current user position and activity completion location for the selected sub-activity (or, more generally, a selected activity), as well as links to video portions that show how the sub-activity can be played.

In one example, the activity card 910 includes a header section 912, an activity identifier 914, and an activity description 920 about the activity. In comparison, the expanded activity card 930 includes additional information related to the activity. In the example illustrated by FIG. 9, the expanded activity card 930 includes a list of some of the available sub-activities 940 available to a video game player. The user interface 900 may receive a selection of a sub-activity 942 within the expanded activity card 930. In the current example, the user interface 900 receives a selection of the sub-activity 942 “Acquire Car” from the list of sub-activities 940. Any of the activity card 910 or the expanded activity card 930 may include information or one or more indicators that indicate whether help is available for the activity. Such information and/or indicators can be presented as a selectable graphical user interface element that triggers the presentation of the available help (e.g., the presentation of the help card 950).

In response to the selection, the user interface 900 displays the help card 950 including additional details and help specific to the sub-activity 942. The help card 950 includes a title 952 of the sub-activity 942, a map 954 of the activity, and links to portions of video content 956 and 958. The map 954 may include a zone of the video game with two locations where other players have completed the activity as well as the current location of the player. A link can be to video showing a game play of another player completing the sub-activity 942 in the zone or at a particular completion location within the zone, where this link is available based on an association between the video and an activity identifier 914 of the sub-activity 942, a zone identifier of the zone, and/or a location identifier (e.g., position data) of the completion location. The link can be presented as a thumbnail in the help card 950. Upon a user selection of the link (e.g., a click on the thumbnail), the video can be played in the help card 950 while the presentation of the map 954 continues. Upon a second selection of the link (e.g., a double click over the thumbnail), the video can be expanded to full screen (e.g., to cover the video content 956). Whether a video portion via a user selection from the help card 950 or via a user selection of the activity completion location 704, the relevant video portion can be presented. Further, the help card 950 can also include other information such as text, graphics, or video links about using a mechanic to complete the activity. This information is available based on an association between the mechanic and the activity identifier 914 of the sub-activity 942 and/or the zone identifier of the zone.

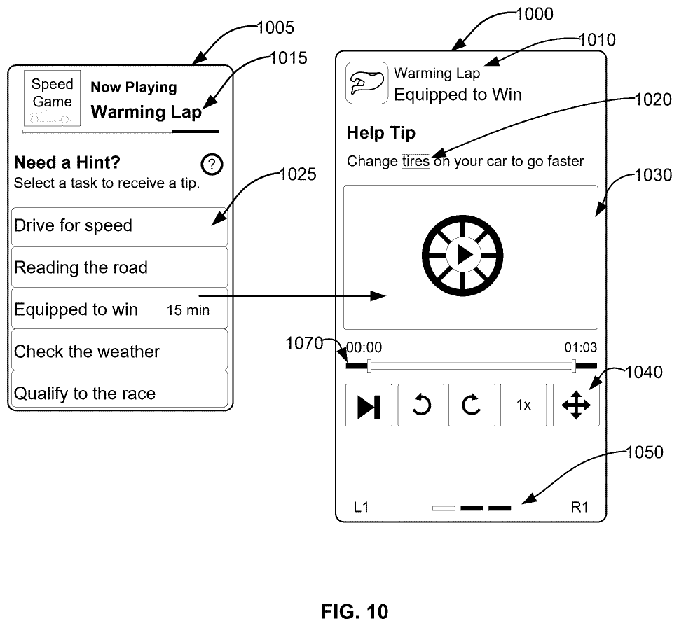

FIG. 10 illustrates an example of a help tip display through a user interface, according to embodiments of the present disclosure. In some embodiments, the video game platform links an activity option displayed as part of the user interface to a hint menu 1005. The hint menu 1005 may include header information 1015, including, but not limited to, identification of the game and the activity in progress, as well as a progress bar showing the player's progress toward completion of the activity. In some embodiments, the hint menu 1005 presents a list of available hints in a menu interface of selectable options 1025. In some embodiments, the selectable options 1025 display the name of the activity and other information including, but not limited to, a duration of time associated with the activity or the help content. In some embodiments, the video game platform receives a user selection of one of the selectable options 1025, in response to which an appropriate help tip window is displayed, such as the help tip window 1000.

The help tip window 1000 includes graphical content, such as a header 1010 containing images and text identifying an activity and sub-activity in progress (e.g. the activity 710 and sub-activity 730A of FIG. 7). In an illustrative example, the header 1010 includes an icon or badge associated with the video game. Alternatively, the icon or badge may represent the activity in progress. In some embodiments, the help tip window 1000 also contains a mechanic tip 1020, describing the use of a mechanic to help the user successfully complete the activity.

In addition, the help tip window 1000 may include several interactive elements, including, but not limited to, audio-visual content 1030, a link 1040 to present the audio-visual content 1030 in a large-size viewer, and a carousel control 1050 to cycle between a number of available mechanic tips 1020. For example, the video game platform may determine that for a given activity, three mechanics are available to a video game player that are associated with successful completion outcomes for a given activity. The carousel control 1050 allows the player to view the mechanic tip 1020 and audio-visual content 1030 for each of the mechanics in a single help tip window 1000. In some embodiments, the header 1010 is static for each carousel control 1050 selection.

In some embodiments, the audio-visual content 1030 includes still frames of in-game images taken from the game itself. In addition, the audio-visual content 1030 can include, but is not limited to, user-generated video and audio recordings of video game content that resulted in successful completion of the activity, identified from data for the plurality of video game players in the data store (e.g. the data store 152 of FIG. 1). In some embodiments, the audio-visual content 1030 is uploaded to the video game platform from user devices. Alternatively, the audio-visual content 1030 may be identified by event data stored in the data store (e.g. the event data 154 of FIG. 1) that may include activity identifiers, mechanic identifiers, estimated length of time for the activity, and time stamp information, among other data, which can be processed to generate appropriate audio or video recordings. The processing can be done automatically. In some embodiments, the audio-visual content 1030 is processed such that the help tip window 1000 presents only a segment of a larger media file. For instance, the help tip window 1000 may include a tracking bar 1070 showing the total duration of the audio-visual content 1030 in one color (e.g. black), with a section of the tracking bar 1070 in a second color (e.g. white) indicating the region of the audio-visual content 1030 containing information relevant to the mechanic tip 1020. In some embodiments, data received from a third party system (e.g. the third party system 190 in FIG. 1) includes spoiler content, including, but not limited to, in-game narrative scenes immediately following successful completion of the activity. The video game platform may exclude such spoiler content from audio-visual content 1030 by limiting the segment of audio-visual content 1030 that is presented in the help tip window 1000 as shown in the tracking bar 1070.

To illustrate, multiple video players may have played the video game and recorded video content showing their playtime. For each of such players, the video game platform receives the video content and event data. The event data indicates the use of a mechanic, timing information about the use, and the impact of the use in an activity (e.g., based on events related to the activity and the mechanic). The video game platform associates the timing with keyframes of the video content to generate a link to a specific portion of the video content (e.g., between two keyframes) showing the use of the mechanic. Such associations may be stored for multiple activities, mechanics, and video content recorded by multiple video game players. When generating the help tip window 1030 about a mechanic in an activity for a particular user, the video game platform may select one or more of the video portions for addition to the help tip window 1030. In particular, the video game platform identifies the specific video portions associated with the activity and the mechanic as a set of candidate video portions. The candidate video portions are ranked according to a set of sort factors. For instance, for each of the candidate video portions, the video game platform may look-up the corresponding event data and determine whether the activity was completed, whether the mechanic had a positive impact, or the like. The video game platform may also determine matches between the video game player that recorded the candidate video portion and the user, such as whether the language of the recorded audio matches the language of the user, the in-game characteristic of the video game player that matches the in-game characteristic of the user, the video game player played the activity at the same difficulty as the user, and the like. The candidate video portions are ranked according to how the sort factors are met. The highest ranked candidate video portion may be presented as the audio-visual content 1030.

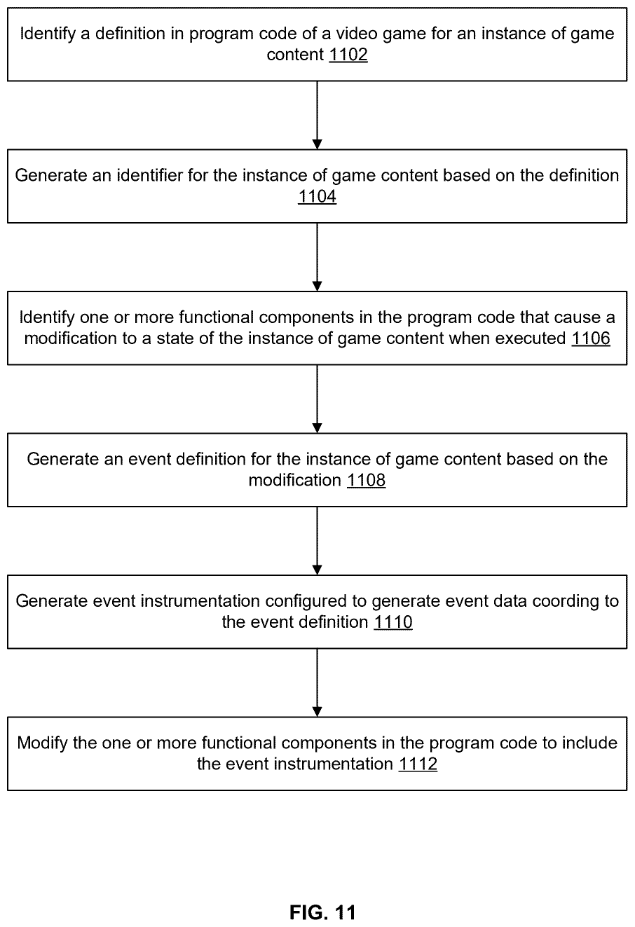

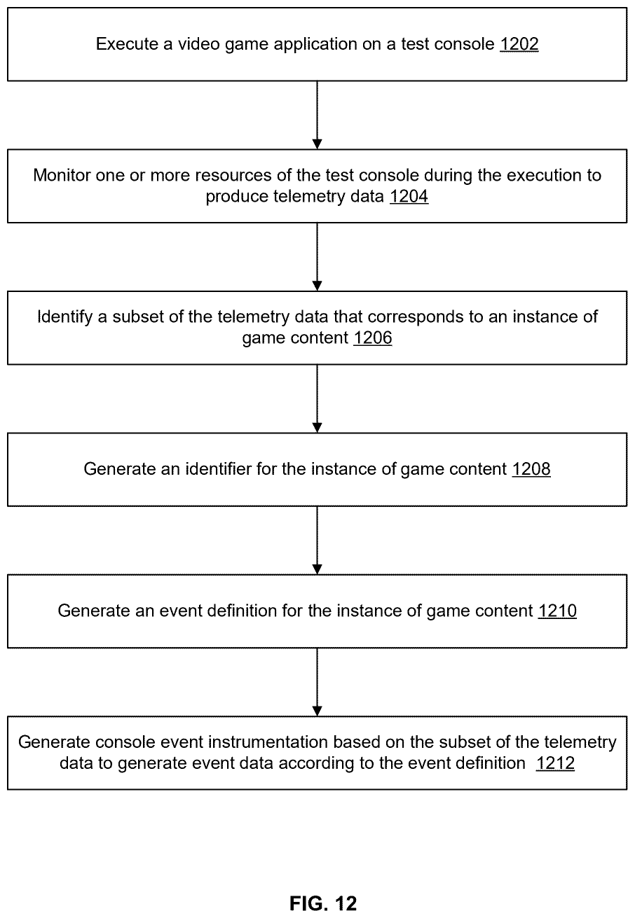

FIGS. 11 and 12 illustrate example flows for instrumenting video games with support for universal game content reporting. The operations of the flows can be implemented as hardware circuitry and/or stored as computer-readable instructions on a non-transitory computer-readable medium of a computer system, such as a video game console and/or a video game platform. As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is required and that certain operations can be omitted.

FIG. 11 illustrates an example of a flow for instrumenting a video game with support for universal game content reporting, according to embodiments of the present disclosure. In an example, the flow includes operation 1102, where a definition in program code of a video game for an instance of game content is identified. As described further herein, this may involve analyzing the program code to locate specific definitions and/or instantiations for various types of game content, such as actors, mechanics, activities, and/or zones. In an example, one or more machine learning models may be executed on the program code to identify the unique instantiations within the program code.

In an example, the flow includes operation 1104, where an identifier for the instance of game content is generated based on the definition in the program code. The identifier for the instance of game content may be a unique identifier for the instance of game content. In an example, generating the identifier includes generating content metadata for the instance of game content, as described further above.

In an example, the flow includes operation 1106, where one or more functional components in the program code are identified that cause a modification to a state of the instance of game content when executed. The functional components may include methods or functions that, when executed, alter the state of the game content, such as by changing a property of the instance of game content. Examples of such changes may include updates to the availability of the instance of game content within the video game, starting and/or ending an activity within the video game, equipping a mechanic, using a mechanic, or the like.

In an example, the flow includes operation 1108, where an event definition for the instance of game content is generated based on the modification. The event definition for the instance of game content may include the identifier for the instance of game content. The event definition may specify the type of event (e.g., start, progress, completion, availability change, etc) based on the corresponding modification effectuated by the one or more functional components in the program code.

In an example, the flow includes operation 1110, where event instrumentation configured to generate event data according to the event definition is generated. The event instrumentation may include program code designed to instantiate an event object with the information from the event definition and dynamic values for one or more attributes defined in the event definition, such as the identifier of an account associated with the video game console that executes the event instrumentation. The event instrumentation may further include program code that causes a video game console executing the event instrumentation to generate and transmit the event data to a video game platform.

In an example, the flow includes operation 1112, where the one or more functional components in the program code are modified to include the event instrumentation. Modifying the one or more functional components may include integrating the generated event instrumentation code into the relevant parts of the program code, ensuring that the specified event data is generated and/or transmitted whenever the corresponding modification to the state of the game content occurs during an execution of the program code.

FIG. 12 illustrates another example of a flow for instrumenting video games with support for universal game content reporting, according to embodiments of the present disclosure. In an example, the flow includes operation 1202, where a video game application is executed on a test console. As described above, the test console may include one or more physical and/or virtual machines that emulate the functionality of a game console, such as a video game console or other video game player devices. Additionally, the test console may include applications and services that emulate the execution of the console system software, enabling a controlled environment to monitor and analyze the game's behavior.

In an example, the flow includes operation 1204, where one or more resources of the test console are monitored during the execution of the video game application to produce telemetry data. As further described above, the test console may be equipped with monitoring tools that track the utilization of various resources, such as processor usage, memory consumption, network bandwidth, graphics buffers, and storage I/O, to provide comprehensive telemetry data during the execution of the video game application.

In an example, the flow includes operation 1206, where a subset of the telemetry data that corresponds to an instance of game content is identified. For example, a subset of the telemetry data may be identified that indicates specific actions or events related to a particular game activity, such as the start and end times of a quest, the interactions with non-playable characters (NPCs), the occurrence of combat events, or the completion of in-game objectives.

This identification process involves filtering and analyzing the telemetry data to extract relevant features and/or patterns that accurately reflect the state and progress of the video game.

In an example, the flow includes operation 1208, where an identifier for the instance of game content is generated. The identifier for the instance of game content may be a unique identifier for the instance of game content. In an example, generating the identifier includes generating content metadata for the instance of game content, as described further above.

In an example, the flow includes operation 1210, where an event definition for the instance of game content is generated. The event definition for the instance of game content may include the identifier for the instance of game content. The event definition may specify the type of event (e.g., start, progress, completion, availability change, etc) based on the corresponding modification effectuated by the one or more functional components in the program code.

In an example, the flow includes operation 1212, where console event instrumentation is generated based on the subset of the telemetry data that generates event data according to the event definition. As described above, console event instrumentation may include logging mechanisms for incorporation and/or installation within the console system software. These components are designed to capture and report specific events in real-time based on the detected resource patterns and output graphics/audio that correspond to the identified instances of game content and their associated events. Upon execution of the video game application by a video game console, the video game console may detect the resource patterns and/or output graphics/audio defined in the console event instrumentation and generate the corresponding event.

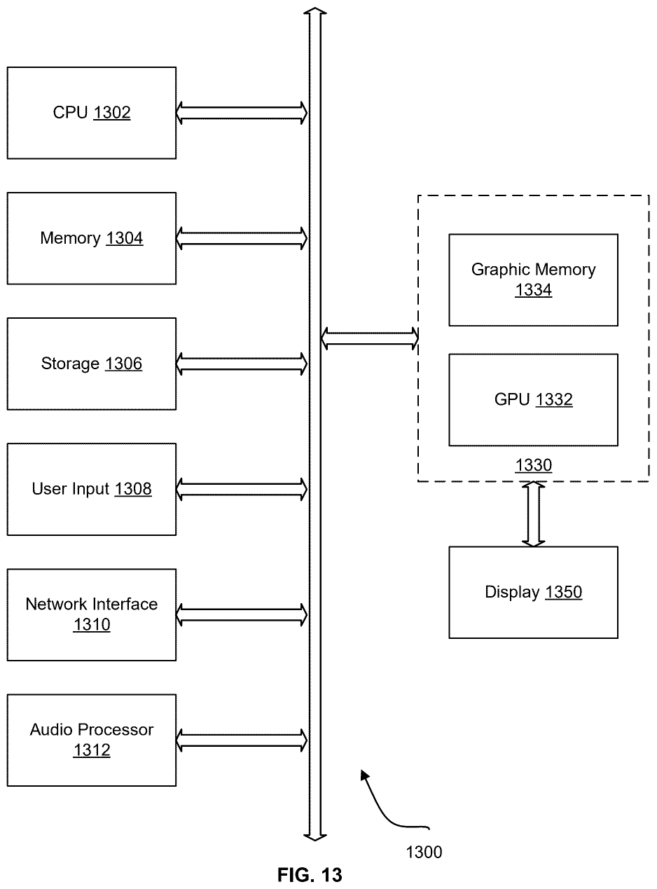

FIG. 13 illustrates an example of a hardware system suitable for implementing a computer system 1300, according to embodiments of the present disclosure. The computer system 1300 represents, for example, a video game console, a video game platform, or other types of a computer system. The computer system 1300 includes a central processing unit (CPU) 1302 for running software applications and optionally an operating system. The CPU 1302 may be made up of one or more homogeneous or heterogeneous processing cores. Memory 1304 stores applications and data for use by the CPU 1302. Storage 1306 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 1308 communicate user inputs from one or more users to the computer system 1300, examples of which may include keyboards, mice, joysticks, touch pads, touch screens, game controllers, virtual reality controllers, still or video cameras, and/or microphones. Network interface 1310 allows the computer system 1300 to communicate with other computer systems via an electronic communications network, and may include wired or wireless communication over local area networks and wide area networks such as the Internet. An audio processor 1312 is adapted to generate analog or digital audio output from instructions and/or data provided by the CPU 1302, memory 1304, and/or storage 1306. The components of computer system 1300, including the CPU 1302, memory 1304, data storage 1306, user input devices 1308, network interface 1310, and audio processor 1312 are connected via one or more data buses 1360.

A graphics subsystem 1330 is further connected with the data bus 1360 and the components of the computer system 1300. The graphics subsystem 1330 includes a graphics processing unit (GPU) 1332 and graphics memory 1334. The graphics memory 1334 includes a display memory (e.g., a frame buffer) used for storing pixel data for each pixel of an output image. The graphics memory 1334 can be integrated in the same device as the GPU 1332, connected as a separate device with the GPU 1332, and/or implemented within the memory 1304. Pixel data can be provided to the graphics memory 1334 directly from the CPU 1302.

Alternatively, the CPU 1302 provides the GPU 1332 with data and/or instructions defining the desired output images, from which the GPU 1332 generates the pixel data of one or more output images. The data and/or instructions defining the desired output images can be stored in the memory 1304 and/or graphics memory 1334. In embodiments, the GPU 1332 includes 3D rendering capabilities for generating pixel data for output images from instructions and data defining the geometry, lighting, shading, texturing, motion, and/or camera parameters for a scene. The GPU 1332 can further include one or more programmable execution units capable of executing shader programs.

The graphics subsystem 1330 periodically outputs pixel data for an image from the graphics memory 1334 to be displayed on the display device 1350. The display device 1350 can be any device capable of displaying visual information in response to a signal from the computer system 1300, including CRT, LCD, plasma, and OLED displays. The computer system 1300 can provide the display device 1350 with an analog or digital signal.

In accordance with various embodiments, the CPU 1302 is one or more general-purpose microprocessors having one or more processing cores. Further embodiments can be implemented using one or more CPUs 1302 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information.

The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, +4%, ±5%, ±8%, ±10%, ±15%, +20%, +25%, or as otherwise known in the art. “Substantially” refers to more than 66%, 75%, 80%, 90%, 95%, 99%, 99.9% or, depending on the context within which the term substantially appears, value otherwise as known in the art.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method implemented by a computer system, the method including:
identifying, by one or more machine learning models, a definition in program code of a video game for an instance of game content;
generating, by the one or more machine learning models, an identifier for the instance of game content based on the definition;
identifying, by the one or more machine learning models, one or more functional components in the program code that cause a modification to a state of the instance of game content when executed;
generating, by the one or more machine learning models, an event definition for the instance of game content based on the modification, wherein the event definition includes the identifier for the instance of game content;
generating, by the one or more machine learning models, event instrumentation configured to, upon execution, generate event data according to the event definition; and
modifying the one or more functional components in the program code to include the event instrumentation.

2. The method of claim 1, wherein, upon execution by the video game console, the event instrumentation further causes transmission of the event data to a video game platform.

3. The method of claim 2, wherein the event data comprises an identification of a user account associated with a video game console; a timestamp indicating when the one or more functional components were executed by the video game console; and the identifier for the instance of game content.

4. The method of claim 2, further comprising:
transmitting the identifier and the event definition for the instance of game content to the video game platform;
wherein in response to receiving the event data from a video game console, the event data is stored in a data store in association with the content metadata and the event definition for the instance of game content.

5. The method of claim 1, further comprising:
identifying, by the one or more machine learning models, a type of game content that corresponds to the instance of game content from a plurality of game content types common to a plurality of video games including the video game based on the definition in the program code; and
generating, by the one or more machine learning models, content metadata for the instance of game content based on the definition in the program code, wherein the content metadata comprises the identifier for the instance of game content and one or more attributes that are common to the type of game content in the plurality of video games.

6. The method of claim 5, wherein the plurality of game content types comprises an activity content type, an actor content type, a mechanic content type, and a zone content type.

7. The method of claim 1, wherein the instance of game content corresponds to an activity in the video game, the one or more functional components correspond to a start of the activity in the video game.

8. The method of claim 1, wherein the instance of game content corresponds to an activity in the video game, the one or more functional components correspond to an end of the activity in the video game, and the event instrumentation generates the event data with a completion status of the activity by a player.

9. The method of claim 1, wherein the instance of game content corresponds to an activity in the video game, the one or more functional components cause the activity to become available in the video game, and the event instrumentation generates the event data to indicate that the activity is available to a player.

10. A computer system comprising:
one or more processors; and
one or more memories storing computer-readable instructions that, upon execution by the one or more processors, configure the computer system to:
identify, by one or more machine learning models, a definition in program code of a video game for an instance of game content;
generate, by the one or more machine learning models, an identifier for the instance of game content based on the definition;
identify, by the one or more machine learning models, one or more functional components in the program code that cause a modification to a state of the instance of game content when executed;
generate, by the one or more machine learning models, an event definition for the instance of game content based on the modification, wherein the event definition includes the identifier for the instance of game content;
generate, by the one or more machine learning models, event instrumentation configured to, upon execution, generate event data according to the event definition; and
modify the one or more functional components in the program code to include the event instrumentation.

11. The computer system of claim 10, wherein, upon execution by the video game console, the event instrumentation further causes transmission of the event data to a video game platform.

12. The computer system of claim 11, wherein the event data comprises an identification of a user account associated with a video game console; a timestamp indicating when the one or more functional components were executed by the video game console; and the identifier for the instance of game content.

13. The computer system of claim 11, wherein the computer-readable instructions further configure the computer system to:
transmit the identifier and the event definition for the instance of game content to the video game platform;
wherein in response to receiving the event data from a video game console, the event data is stored in a data store in association with the content metadata and the event definition for the instance of game content.

14. The computer system of claim 10, wherein the computer-readable instructions further configure the computer system to:
identify, by the one or more machine learning models, a type of game content that corresponds to the instance of game content from a plurality of game content types common to a plurality of video games including the video game based on the definition in the program code; and
generate, by the one or more machine learning models, content metadata for the instance of game content based on the definition in the program code, wherein the content metadata comprises the identifier for the instance of game content and one or more attributes that are common to the type of game content in the plurality of video games.

15. The computer system of claim 14, wherein the plurality of game content types comprises an activity content type, an actor content type, a mechanic content type, and a zone content type.

16. One or more non-transitory computer-readable media storing computer-readable instructions that, upon execution on a computer system, cause the computer system to perform operations comprising:
identifying, by one or more machine learning models, a definition in program code of a video game for an instance of game content;
generating, by the one or more machine learning models, an identifier for the instance of game content based on the definition;
identifying, by the one or more machine learning models, one or more functional components in the program code that cause a modification to a state of the instance of game content when executed;
generating, by the one or more machine learning models, an event definition for the instance of game content based on the modification, wherein the event definition includes the identifier for the instance of game content;
generating, by the one or more machine learning models, event instrumentation configured to, upon execution, generate event data according to the event definition; and
modifying the one or more functional components in the program code to include the event instrumentation.

17. The one or more non-transitory computer-readable media of claim 16, wherein, upon execution by the video game console, the event instrumentation further causes transmission of the event data to a video game platform.

18. The one or more non-transitory computer-readable media of claim 17, wherein the event data comprises an identification of a user account associated with a video game console; a timestamp indicating when the one or more functional components were executed by the video game console; and the identifier for the instance of game content.

19. The one or more non-transitory computer-readable media of claim 17, wherein the operations further comprise:
transmitting the identifier and the event definition for the instance of game content to the video game platform;
wherein in response to receiving the event data from a video game console, the event data is stored in a data store in association with the content metadata and the event definition for the instance of game content.

20. The one or more non-transitory computer-readable media of claim 16, wherein the operations further comprise:
identifying, by the one or more machine learning models, a type of game content that corresponds to the instance of game content from a plurality of game content types common to a plurality of video games including the video game based on the definition in the program code; and
generating, by the one or more machine learning models, content metadata for the instance of game content based on the definition in the program code, wherein the content metadata comprises the identifier for the instance of game content and one or more attributes that are common to the type of game content in the plurality of video games.
